(19) United States
(12) Patent Application Publication
(10) Pub. No.: US 2016/0050879 A1
(43) Pub. Date: Feb. 25, 2016

(54) LIVESTOCK SUPPORT SYSTEM

(71) Applicant: IP Holdings, Inc., Oceanside, CA (US)

(72) Inventors: Timothy D. Schnell, Rancho Santa Fe, CA (US); Paul H. Petersen, Glen, MT (US)

(21) Appl. No.: 14/825,550

(22) Filed: Aug. 13, 2015

Related U.S. Application Data
(60) Provisional application No. 62/040,338, filed on Aug. 21, 2014.

(51) Int. Cl. A01K 1/00

(52) U.S. Cl. CPC A01K 1/00

(57) ABSTRACT

A portable livestock support system can be provided for supporting a suckling animal relative to a mother. The system is adjustable in multiple dimensions to accommodate animals of varying sizes. The system supports the animal during positioning for suckling and during suckling. A method of using the system also is described.

### CROSS-REFERENCE TO RELATED APPLICATIONS

The present application claims priority under 35 U.S.C. §119(e) to U.S. Provisional Application No. 62/040,338 filed on Aug. 21, 2014, which is hereby incorporated by reference in its entirety.

### BACKGROUND

1. Field

The present invention generally relates to livestock support systems. More specifically, the present invention relates to such systems including an apparatus that may be used to support an animal during suckling and a method of using such an apparatus.

2. Description of the Related Art

Farmhands and others involved in agriculture may physically support a newborn animal to enable access to the mother's teat for suckling. The animal typically is supported on a thigh of the farmhand, while the shin of the other leg rests against the floor. For calves, the farmhand must be positioned adjacent the cow's rear leg, which positions the farmhand in a location that could allow the cow to kick at the farmhand. In addition, such a position can be tiring to maintain during the entire time that the calf is suckling. The person must assume this position every time the calf needs to feed. With the rising value of every head of livestock, farmers are willing to assist with feeding until the animal is able to feed itself or be weaned.

### SUMMARY

The existing method of supporting livestock is labor intensive and laborious. The farmhand must kneel each time the calf feeds, often on rough or unstable barn floors. The person must also be close to the legs of the mother. Based on human anatomy, the farmhand's torso must be very close to the side of the mother. The legs of the farmhand are typically underneath the body of the mother. The kneeling position makes it nearly impossible to move away from the mother if the mother becomes agitated. The unpredictable nature of livestock and the uncomfortable position assumed by the farmhand make it desirable to create a new livestock support system.

Livestock support systems described herein can be adjusted to support livestock of various sizes and portable to function in a variety of environments. For instance, livestock support systems according to some embodiments can be moved to the desired location relative to the mother. The livestock support system can be movable, for example, by the use of wheels. According to certain embodiments, the length of the livestock support system can be independently adjustable, e.g., by adjusting a center support. The length of the livestock support system can be configured to span a desired length relative to a body length of the suckling animal. In some embodiments, the height of the livestock support system is independently adjustable, e.g., by adjusting the legs of the system. The height adjustment allows the suckling animal to be placed at the right height relative to the mother's teat or at a desired height relative to the leg length of the suckling animal. In some embodiments, the width of livestock support system is independently adjustable, e.g., by adjusting a center support, the saddle, the legs and/or other components of the system. For instance, the saddle can be adjusted to the size (e.g., a width of a torso) of the suckling animal. In other systems, the legs and/or the center support is adjusted to better distribute the weight of the animal. Thus, the user can fine tune the livestock support system to best suit a size and/or weight and/or weight distribution of the suckling animal.

A livestock support system can be provided for supporting a suckling animal relative to a mother. The device may comprise a body portion having at least a first longitudinal bar, the body portion having a length along the longitudinal bar, a width and a height. The device may comprise at least three wheels coupled to the body portion. In some embodiments, at least one of the length, the width or the height is adjustable relative to the size of the mother or the sucking animal.

The device may comprise a vertical bar coupled to each wheel. In some embodiments, the vertical bar can be moved to adjust the height. The device may comprise a front bar coupled to the first longitudinal bar. The device may comprise a side bar coupled to the front bar. In some embodiments, the angle of the side bar relative to the front bar can be moved to adjust the width. The device may comprise a second longitudinal bar. In some embodiments, the relative movement of the first longitudinal bar relative to the second longitudinal bar adjusts the length. The device may comprise at least one lock to prevent movement of the wheels. The device may comprise a saddle configured to be coupled to the first longitudinal bar. In some embodiments, the saddle can be adjusted to a different position along at least a portion of the length of the first longitudinal bar. In some embodiments, the saddle comprises padding. The device may comprise a strap configured to be coupled to the saddle. In some embodiments, the strap is configured to extend around the haunches of the suckling animal. In some embodiments, the strap is configured to prevent movement of the sucking animal in at least one direction.

A portable livestock support system can be provided for supporting a suckling animal relative to a mother. The device may comprise a body portion having at least a first longitudinal bar, and a length along the longitudinal bar, a width and a height. The device may comprise at least three supports coupled to the body portion. In some embodiments, at least one of the length, the width or the height is adjustable relative to the size of the mother or the suckling animal. In some embodiments, he supports can be moved to adjust the height. The livestock support system can comprise a front bar coupled to the first longitudinal bar. The livestock support system can comprise a side bar coupled to the front bar. In some embodiments, the angle of the side bar relative to the front bar can be moved to adjust the width. The livestock support system can comprise a second longitudinal bar. In some embodiments, movement of the first longitudinal bar relative to the second longitudinal bar can adjust the length. In some embodiments, each support can comprise a wheel. The livestock support system can comprise at least one lock to reduce or eliminate the likelihood of unintended movement of the wheels. The livestock support system can comprise a saddle configured to be coupled to the first longitudinal bar. In some embodiments, the saddle can be adjusted to a different position along at least a portion of the length of the first longitudinal bar. In some embodiments, the saddle can comprise padding. The livestock support system can comprise a strap configured to be coupled to the saddle. In some embodiments, the strap can be configured to extend around the haunches of the suckling animal. In some embodiments, the strap can be configured to reduce or eliminate the likelihood of unintended movement of the sucking animal in at least one direction.

A method of using a livestock support system can include providing a livestock support system comprising a body portion having at least a first longitudinal bar, and a length along the longitudinal bar, a width and a height. The method can include adjusting at least one of the length, the width or the height relative to the size of a suckling animal or the mother of the suckling animal. The method can include lowering the suckling animal into the livestock support system. The method can include moving the suckling animal relative to the mother. In some embodiments, adjusting the length can comprise moving a second longitudinal bar relative to the first longitudinal bar. In some embodiments, adjusting the width can comprise moving a side bar relative to a front bar, wherein the front bar is coupled to the first longitudinal bar. In some embodiments, adjusting the height can comprise moving a vertical bar relative to a bracket, wherein the bracket is coupled to the body portion. In some embodiments, lowering the suckling animal can comprise lowering the suckling animal into a saddle. The method can comprise the step of securing a strap around the haunches of the suckling animal.

### BRIEF DESCRIPTION OF THE DRAWINGS

The above-mentioned features, aspects, and advantages, as well as other features, aspects, and advantages of the present technology, will now be described in connection with various embodiments, with reference to the accompanying drawings. The illustrated embodiments, however, are merely examples and are not intended to be limiting. Like reference numbers and designations in the various drawings indicate like elements.

FIG. 1 illustrates a perspective view of an embodiment of a livestock support system.

FIG. 2 illustrates an exploded view of the livestock support system of FIG. 1.

FIG. 3 illustrates a top perspective view of livestock support system of FIG. 1.

FIG. 4 illustrates a back view of livestock support system of FIG. 1.

FIG. 5 illustrates a side view of livestock support system of FIG. 1.

FIG. 6 illustrates a perspective view of livestock support system of FIG. 1 with the saddle removed.

FIG. 7 illustrates one embodiment of the adjustable length of the livestock support system of FIG. 1.

FIG. 8A illustrates one embodiment of the adjustable height of the livestock support system of FIG. 1 in a first position.

FIG. 8B illustrates one embodiment of the adjustable height of the livestock support system of FIG. 1 in a second position.

FIG. 9A illustrates one embodiment of the adjustable saddle of the livestock support system of FIG. 1 in a first position.

FIG. 9B illustrates one embodiment of the adjustable saddle of the livestock support system of FIG. 1 in a second position

FIG. 10 illustrates a top perspective view of livestock support system of FIG. 1 with the legs of the suckling animal shown in dashed lines.

FIG. 11 illustrates a side view of livestock support system of FIG. 1 with the body of the suckling animal shown in dashed lines.

### DETAILED DESCRIPTION

In the following detailed description, reference is made to the accompanying drawings, which form a part of the present disclosure. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and form part of this disclosure. For example, a system or device may be implemented or a method may be practiced using any number of the aspects set forth herein. In addition, such a system or device may be implemented or such a method may be practiced using other structures, functionality, or structures and functionality in addition to or other than one or more of the aspects set forth herein. Alterations and further modifications of the inventive features illustrated herein, and additional applications of the principles of the inventions as illustrated herein, which would occur to one skilled in the art and having possession of this disclosure, are to be considered within the scope of the present disclosure.

Descriptions of unnecessary parts or elements may be omitted for clarity and conciseness, and like reference numerals refer to like elements throughout. In the drawings, the size and thickness of layers and regions may be exaggerated for clarity and convenience.

Features of the present disclosure will become more fully apparent from the following description and appended claims, taken in conjunction with the accompanying drawings. It will be understood these drawings depict only certain embodiments in accordance with the present disclosure and, therefore, are not to be considered limiting of its scope; the disclosure will be described with additional specificity and detail through use of the accompanying drawings. An apparatus, system or method according to some of the described embodiments can have several aspects, no single one of which necessarily is solely responsible for the desirable attributes of the apparatus, system or method. After considering the following discussion, one will understand how illustrated features serve to explain certain principles of the present disclosure.

The livestock support system described herein can be utilized with a variety of animals. Some non-limiting examples of such animals include cattle, sheep, goats, horses, pigs, alpacas, bison, camels, deer, dogs, donkeys, llamas, mules, and reindeer. The livestock support system can be utilized in zoological environments, and therefore support non-domestic animals. Some non-limiting examples of such animals include elephants, rhinoceros, bears, zebras, giraffes, and antelope. The term “suckling animal” extends to all animals that nurse from a mother after birth. In some examples, calves and cows are used an exemplary animals.

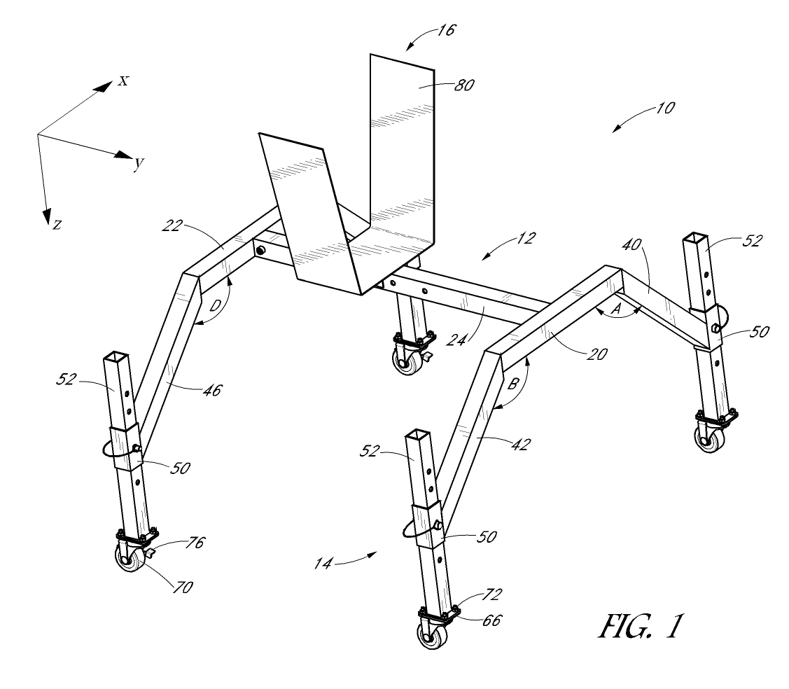

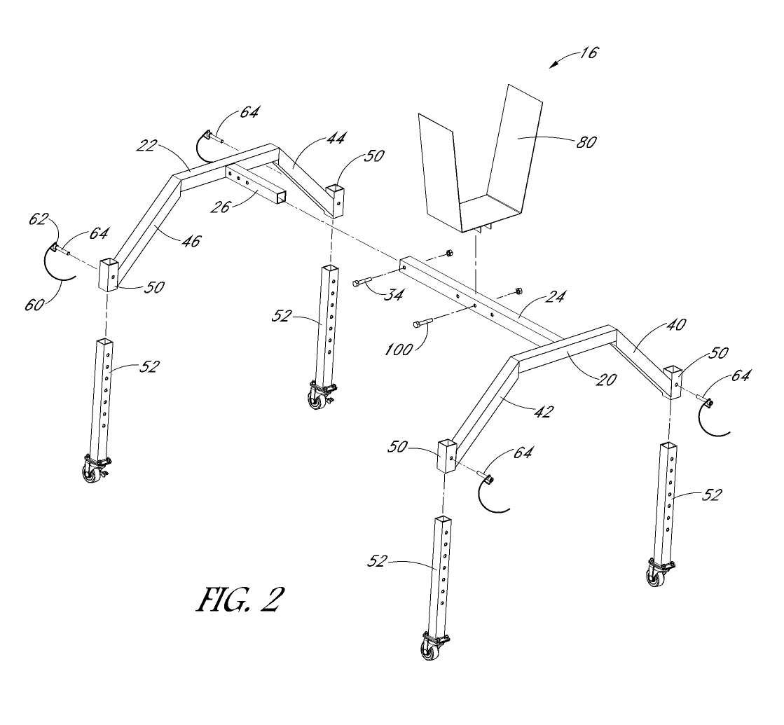

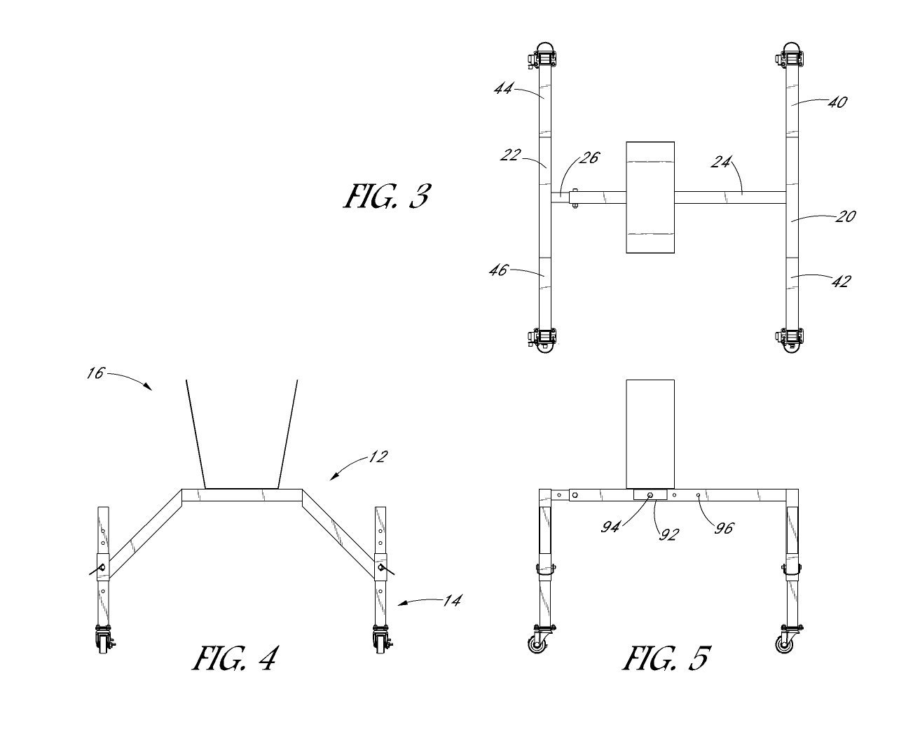

As shown in FIG. 1-5, some embodiments of the livestock support system 10 comprise a center support 12. One or more legs 14 can be coupled to the center support 12. The one or more leg 14 can be positioned at the ends of the center support 12. The one or more legs 14 can be positioned at various locations along the center support 12. The one or more legs 14 can be movable (e.g., positionable and respositionable) along the center support 12.

A saddle 16 can be coupled to the center support 12. The saddle 16 can be movable along the center support 12. The saddle 16 can be located as desired between the one or more legs 14. The saddle 16 can be movable relative to the one or more legs 14.

Solely for proving a non-limiting frame of reference, the length of the livestock support system 10 extends along the center support 12 in the Y direction. The width of the livestock support system 10 extends laterally relative to the center support 12 in the X direction. The height of the livestock support system 10 extends vertically relative to the center support 12 in the Z direction. In some embodiments, the livestock support system 10 is adjustable in the X direction, the Y direction and/or the Z direction, as described herein.

The term “coupled” as used herein can refer to direct coupling or indirect coupling. Two components can be directly coupled if they abut, touch, or engage (A enjoined to B). Two components can be indirectly coupled if there is one or more intervening component that prevents direct coupling (A enjoined to X and X enjoined to B) but facilitates indirect coupling. Coupled components may be fixed relative to each other (e.g., weld, glue, affixed) or temporally fixed (e.g., Velcro, snap, fastener, zip tie, pin/slot, ratchet/pawl). Coupled components describe herein can be integrally formed (e.g., unitary, monolithic). Coupled components can move relative to each other (e.g., slide, roll, and pivot). Typically, the motion of coupled components is constrained in at least one direction.

As shown in FIG. 1-5, the center support 12 may generally span the length of the livestock support system 10. When a suckling animal is lowered into the livestock support system 10, a portion of the center support 12 can extend generally parallel to the spine of the animal (see, e.g., FIG. 11). A saddle 16 can be supported by the center support 12. The saddle 16 can provide support for the suckling animal. In some configurations, the saddle 16 can provide both vertical and lateral support for the suckling animal. In some embodiments, the saddle 16 will engage at least one side of the animal near the ribs. In some embodiments, the saddle 16 will engage each side of the animal near the ribs. The saddle 16 may be several inches wide and several inches deep, in order to support and provide stability to the animal. In some configurations, a variety of saddle sizes and configurations can be provided such that a variety of saddles 16 can be used with any support system 10. In some configurations, the saddle 16 itself can be adjustable and can be used with pads of varying dimensions to provide flexibility to the size and type of animal that is supported.

The center support 12 can be coupled to one or more legs 14. The legs 14 provide stability for the livestock support system 10. In some configurations, the legs 14 act as outriggers and reduce or eliminate the likelihood of the livestock support system 10 tipping over. In some configurations, the one or more legs 14 can include wheels 70. The wheels 70 can enable the livestock support system 10 to be moved. The wheels 70 can be any suitable type or configuration (e.g., casters, rollers, wheels, etc.).

The livestock support system 10 can be portable. Because of its portability, the livestock support system 10 allows a user (e.g., a farmhand or a ranch hand) to move the livestock support system 10 from the location of the suckling animal to the mother. In addition, because of its portability, the livestock support system 10 allows the user to move the livestock support system 10 from one location to another or from one animal to another. In some configurations, the movement is possible with the suckling animal secured in position relative to the livestock support system. In some configurations, the livestock support system 10 can be less than about 48 inches in total length and/or less than 25 pounds, enhancing portability.

As shown best in FIGS. 1-3, the center support 12 can include a front bar 20 that generally located at or near one end of the livestock support system 10. The center support 12 can include a back bar 22 that is generally located at or near the other end of the livestock support system 10. In the illustrated embodiment, the front bar 20 and the back bar 22 are approximately equal in size (e.g., same length, same width, and same cross-sectional area). In other embodiments, the front bar 20 and the back bar 22 are different. For instance, one bar 20, 22 may have a different length, width, cross-sectional area etc. In some embodiments, for example but without limitation, the front bar 20 supports more of the weight of the animal and therefore has a larger cross-sectional area.

The term “bar” can include any longitudinally extending piece of material. In some embodiments, the bar is solid and in other embodiments, the bar is hollow. The bar can comprise any cross-sectional shape including square, rectangular, oval, circular, elliptical, and triangular. The bar can be formed of any material include metals such as steel, iron, and aluminum, zinc, tin, nickel, copper, lead; polymers such polyethylene (PE), polypropylene (PP) and polyvinyl chloride (PVC), polyethylene terephthalate (PET,), polyethylene (PE, LDPE, HDPE), Polypropylene (PP); and natural materials including wood. In addition, while the illustrated configurations generally use the term “bar” in connection with straight components, the term “bar” also can be used to describe a component that comprises a bend along at least a portion of the length of the component.

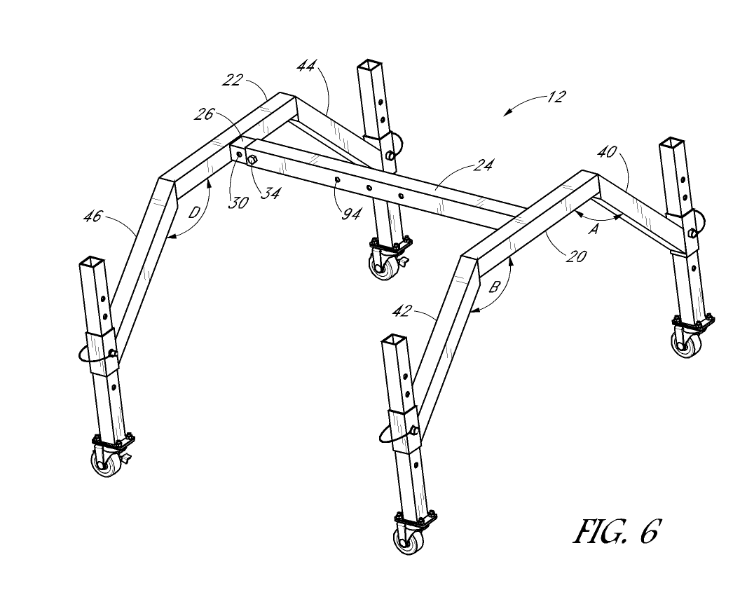

As shown in FIGS. 6-7, the center support 12 can comprise an outer longitudinal bar 24. In some embodiments, such as the embodiment shown in FIGS. 5 and 6, the center support 12 includes an inner longitudinal bar 26. The inner longitudinal bar 26 can be received within the outer longitudinal bar 24. In some embodiments, the inner longitudinal bar 26 telescopes within the outer longitudinal bar 24. In some embodiments, the inner longitudinal bar 26 slides relative to the outer longitudinal bar 24.

In the illustrated configuration, the inner longitudinal bar 26 and the outer longitudinal bar 24 cooperate to extend the length of the livestock support system 10. For instance, the inner longitudinal bar 26 can comprise one or more holes 30 (e.g., a series of holes 30) and the outer longitudinal bar 24 can comprise one or more holes 32 (e.g., a series of holes 32). A pin 34 can be inserted when a hole 30 aligns with a hole 32. The pin 34 prevents inadvertent adjustments of the length of the livestock support system 10. Any suitable component can be used as the pin 34. For example, the pin 34 can be a threaded fastener, a wire loop or the like.

Other means of adjustment of the center support 12 are possible. For instance, a ratchet could be coupled to one longitudinal bar 24, 26 and a pawl coupled to the other longitudinal bar 24, 26. For instance, a turnbuckle (not shown) could be disposed between inner longitudinal bar 26 and the outer longitudinal bar 24. Rotation of the turnbuckle would cause the inner longitudinal bar 26 and the outer longitudinal bar 24 to separate. The same effect could be achieved with a threaded rod coupled to one longitudinal bar 24, 26 and a nut coupled to the other longitudinal bar 24, 26. The center support 12 can comprise a “means for” extending the inner longitudinal bar 26 relative to the outer longitudinal bar 24. The center support 12 can comprise a “means for” adjusting the length of the livestock support system 10.

As described above and with reference to FIG. 6, in some embodiments, the center support 12 comprises the front bar 20 and/or the back bar 22. The front bar 20 can be coupled to one longitudinal bar 24, 26 and the back bar 22 can be coupled to the other longitudinal bar 24, 26. In FIG. 1, the front bar 20 is coupled to the outer longitudinal bar 24 and the back bar 22 is coupled to the inner longitudinal bar 26. The front bar 20 can be approximately centered on the outer longitudinal bar 24 or offset toward the right or left of the livestock support system 10. As used herein, the terms “right” and “left” refer to the orientation as viewed from the front of livestock support system 10 (closest to the front bar 20) and the terms are solely used in a non-limiting manner in order to assist with description of the illustrated configuration. The back bar 22 can be approximately centered on the inner longitudinal bar 26 or offset toward the right or left of the livestock support system 10. The front bar 20 can be approximately the same size as the back bar 22 or a different size. The front bar 20 and/or the back bar 22 can be reduced in size or eliminated.

In some embodiments, the center support 12 comprises one or more right side bars 40, 44 and/or one or more left side bars 42, 46. The front bar 20 can be coupled to a right side bar 40 and/or a left side bar 42. The back bar 22 can be coupled to a right side bar 44 and/or a left side bar 46. The right side bars 40, 44 can be approximately the same size as each other (e.g., length, width) or a different size. The left side bars 42, 46 can be approximately the same size as each other (e.g., length, width) or a different size. The right side bars 40 can be approximately the same size as the left side bar 42 (e.g., length, width) or a different size. The livestock support system 10 may have greater stability if the right side bar 40 is approximately the same size as the left side bar 42. The right side bars 44 can be approximately the same size as the left side bar 46 (e.g., length, width) or a different size. The livestock support system 10 may have greater stability if the right side bar 44 is approximately the same size as the left side bar 46.

The right side bar 40 forms an angle A with the front bar 20 and the left side bar 42 forms an angle B with the front bar 20. The right side bar 44 forms an angle C with the back bar 22 and the left side bar 46 forms an angle D with the back side bar 22. The angles A, B, C, D may be the same as any other angle A, B, C, D or different from any other angle A, B, C, D. In some embodiments, the angle A, B, C, and/or D is less than 180 degrees, less than 170 degrees, less than 160 degrees, less than 150 degrees, less than 140 degrees, less than 130 degrees, less than 120 degrees, less than 110 degrees, less than 100 degrees, less than 90 degrees, between 160 and 110 degrees, between 140 and 130 degrees, approximately 135 degrees, approximately 90 degrees. The angles A and/or B may form an obtuse angle with the front bar 20. The angles C and/or D may form an obtuse angle with the back bar 22. The obtuse angle can widen the stance of the livestock support system 10 from the footprint of the front bar 20 and the back bar 22. The obtuse angle can reduce the material of the livestock support system 10. For instance, the right side bar 40 represents the shortest distance between the front bar 20 and a bracket 50.

The center support 12 can have a number of configurations. For clarity, the configurations include alterations in the arrangement of the front bar 20, the back bar 22, the outer longitudinal bar 24, and the inner longitudinal bar 26. For example, in some configurations, the constructions of the front bar 20, the back bar 22, the outer longitudinal bar 24 and the inner longitudinal bar 26 can include I shaped, T shaped, J shaped, and + shaped configurations. The side bars 40, 42, 44, 46 can extend at any angle from the front bar 20 and the back bar 22, as described herein. In some configurations one or more side bars 40, 42, 44, 46 is eliminated or reduced in size relative to the other side bars. In some embodiments, the right side bar 40 and the left side bar 42 are approximate the same size, and the right side bar 44 and the left side bar 46 are approximately the same size. In some embodiments, the right side bars 40, 44 and left side bars 42, 46 are all approximately the same size. In some configurations, the front bar 20 and the associated side bars and/or the back bar 22 and the associated side bars can be integrally formed in an arcuate configuration or the like.

The front bar 20, the back bar 22, the outer longitudinal bar 24, and the inner longitudinal bar 26 can form a generally I shaped configuration, as shown in FIG. 6. In the I configuration, the front bar 20 can be approximately centered on the outer longitudinal bar 24 and back bar 22 can be approximately centered on the inner longitudinal bar 26. The front bar 20 can be approximately the same size as the back bar 22. In the I configuration, the front bar 20 can be coupled to the right side bar 40 and the left side bar 42. In the I configuration, the back bar 22 can be coupled to the right side bar 44 and the left side bar 46.

The front bar 20, the back bar 22, the outer longitudinal bar 24, and the inner longitudinal bar 26 can form a generally T shaped or tripod configuration. For example, in some such configurations, one of the front bar 20 or the back bar 22 can be eliminated or reduced in size compared to the other bar 20, 22. In some embodiments, the front bar 20 is approximately centered on the outer longitudinal bar 24. The front bar 20 can be coupled to the right side bar 40 and the left side bar 42. The back bar 22 is approximately centered on the inner longitudinal bar 26. In some embodiments, the back bar 22 can be reduced in size relative to the front bar 20. The back bar 22 can be coupled to the right side bar 44 and the left side bar 46. In some embodiments, the back bar 22 can be eliminated. The inner longitudinal bar 26 can be coupled to the vertical bar 52. In some configurations, the generally vertical bar 52 can be combined with the back bar 22. In some configurations, the number of the vertical bars 52 can be reduced to three (e.g., the vertical bar 52 coupled to the right side bar 40, the vertical bar 52 coupled to the left side bar 42, and the vertical bar 52 coupled to the back bar 22 and/or the inner longitudinal bar 26). In such configurations, the number of wheels can be reduced to three.

In some embodiments of the generally T shaped configuration, the back bar 22 is approximately centered on the inner longitudinal bar 26 and the front bar 20 is eliminated or reduced in size relative to the back bar 22 in any of the manners described above with respect to the rear bars. The outer longitudinal bar 24 can be coupled to the vertical bar 52. In some configurations, the generally vertical bar 52 can be combined with the front bar 20. In such configurations, the number of the vertical bars 52 can be reduced to three (e.g., a vertical bar 52 coupled to the right side bar 44, a vertical bar 52 coupled to the left side bar 46, and a vertical bar 52 coupled to the front bar 20 and/or the outer longitudinal bar 24).

The front bar 20, the back bar 22, the outer longitudinal bar 24, and the inner longitudinal bar 26 can form a generally J shaped configuration. One of the front bar 20 or the back bar 22 can be offset relative to the corresponding longitudinal bar 24, 26. For instance, in some embodiments, the front bar 20 can be offset to one direction (e.g., right or left) on the outer longitudinal bar 24. The front bar 20 can be coupled to the right side bar 40 and the left side bar 42. The back bar 22 can be approximately centered on the inner longitudinal bar 26. The back bar 22 can be coupled to the right side bar 44 and the left side bar 46. In some embodiments, the number of vertical bars 52 is four (e.g., two the vertical bar 52 coupled to the right side bars 40, 44 and two vertical bar 52 coupled to the left side bars 42, 46).

In some embodiments, the front bar 20 extends only from one side (e.g., right side) of the outer longitudinal bar 24. In some embodiments, the corresponding side bar (e.g., left side bar 42) can be eliminated. In such configurations, the number of the vertical bars 52 can be reduced to three (e.g., the vertical bar 52 coupled to right side bar 40, the vertical bar 52 coupled to right side bar 44, and the vertical bar 52 coupled to the left side bar 46). In this embodiment, the number of wheels can be reduced to three. In some embodiments, the front bar 20 is approximately centered on the outer longitudinal bar 24 and the back bar is offset relative to the inner longitudinal bar 26. In some embodiments, the back bar extends only from one side (e.g., right or left). In some embodiments, the number of vertical bars 52 is four (as described above) or three (as described above). Any number of vertical bars can be used keeping in mind a goal of stably supporting an animal.

The front bar 20, the back bar 22, the outer longitudinal bar 24, and the inner longitudinal bar 26 can form a generally + shaped configuration. In some embodiments, the front bar 20 and the back bar 22 are reduced in size. For instance, in some embodiments, the front bar 20 is approximately centered on the outer longitudinal bar 24. The front bar 20 can be coupled to the right side bar 40 and the left side bar 42. The back bar 22 can be approximately centered on the inner longitudinal bar 26. The back bar 22 can be coupled to the right side bar 44 and the left side bar 46. A middle bar (not shown) can be approximately centered on the outer longitudinal bar 24. The middle bar can be greater in size than one or more of the front bar 20 and the back bar 22. The middle bar can include a right side bar (not shown) and a left side bar (not shown). The right side bar and the left side bar can be substantially similar to the right side bars 40, 44 and the left side bars 42, 46 described herein. In some embodiments, the front bar 20 and/or the back bar 22 are eliminated. The outer longitudinal bar 24 and/or the inner longitudinal bar 26 can include brackets 50, and each can be coupled to the vertical bar 52.

One or more bars of the center support 12 can include padding 36 as shown in FIG. 7. For instance, the front bar 20 can include padding 36 to reduce or eliminate the likelihood of injury to the animals. The outer longitudinal bar 24 can include padding 36 to support the underside of the animal and provide comfort. The back bar 22 can include padding 36 to reduce or eliminate the likelihood of injury to the back legs of the supported animal. In some embodiments, the padding 36 can be easily removed. In some embodiments, the padding 36 can be cheaply replaced. In some embodiments, the padding 36 is washable. The padding 36 can be coupled to the center support 12 via removable fasteners (not shown) including snaps, buttons, Velcro, and adhesive, for example but without limitation.

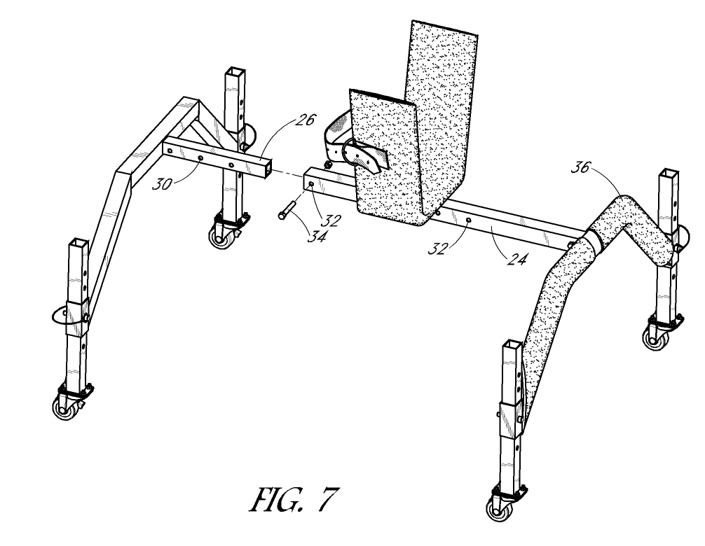

The center support 12 can be coupled to the legs 14 in any suitable manner. As mentioned herein and as shown in FIGS. 8A and 8B, the brackets 50 can be coupled to the right side bars 40, 44 and the left side bars 42, 46. The left side bar 42 is shown in FIGS. 8A-8B. The bracket 50 can be configured to be coupled to a vertical bar 52 of the leg 14. For instance, the vertical bar 52 can be received within the bracket 50. In some embodiments, the inner vertical bar 52 telescopes within the bracket 50. In some embodiments, the vertical bar 52 slides along the bracket 50. The top of the vertical bar 52 can be capped. In most positions, the illustrated vertical bar 52 will extend beyond the bracket 50. The cap can be configured to be flush with the top of the vertical bar 52, for example but without limitation.

The bracket 50 and the vertical bar 52 can cooperate to extend the height of the livestock support system 10. For instance, the bracket 50 can comprise one or more holes 54 (e.g., series of holes 54) and the vertical bar 52 can comprise one or more holes 56 (e.g., series of holes 56). A pin 58 can be inserted when the hole 54 of the bracket 50 aligns with one of the series of holes 56 of the vertical bar 52. The pin 58 reduced or eliminates the likelihood of an inadvertent adjustment of the height of the livestock support system 10. The pin 58 can have any suitable configuration, include any of those described above for the pin 34.

Other means of adjustment are possible. For instance, a ratchet could be coupled to the bracket 50 or the vertical bar 52 and a pawl can be coupled to the other component. For instance, a turnbuckle (not shown) could be disposed between the bracket 50 and the vertical bar 52. Rotation of the turnbuckle would cause the bracket 50 and vertical bar 52 to separate. The same effect could be achieved with a threaded rod coupled to the vertical bar 52 and a nut coupled to the bracket 50. The livestock support system 10 can comprise a “means for” extending the vertical bar 52 relative to the bracket 50. The livestock support system 10 can comprise a “means for” adjusting the height of the livestock support system 10.

The pin 58 can include a wire 60. The wire 60 can extend through a head 62 of the pin 58, wrap around the bracket 50 and couple to a shaft 64 of the pin 58 (e.g., by twisting around the shaft 64). The wire 60 reduces or eliminates the likelihood of the pin 58 disengaging. The pin 34 may have a similar wire.

In some embodiments, the livestock support system 10 comprises one or more sets of vertical bars 52. In some embodiments, a first set of vertical bars 52 includes a plurality of vertical bars 52 (e.g., two, three, four, five, six) and a second set of vertical bars 52 includes a plurality of vertical bars 52 (e.g., two, three, four, five, six). As one example, the livestock support system 10 can include a first set of vertical bars 52 that are a first height, and a second set of vertical bars 52 that are a second height greater than the first height. In some embodiments, both sets of vertical bars 52 are configured to engage with the bracket 50. The farmhand can use the first set of vertical bars 52 when the mother is a shorter breed (e.g., goat) and the second set of vertical bars 52 when the mother is a taller breed (e.g. cow). The second set of vertical bars 52 could be interchangeable with the first set of vertical bars 52 to allow for an extended leg 14 for larger animals. In some methods, the height of the leg 14 can be adjusted by using one set of vertical bars 52 instead of another set of vertical bars 52. In some embodiments, the bracket 50 does not surround the vertical bars 52. In this configuration, the first set of vertical bars 52 can be thinner to support lighter animals. The second set of vertical bars 52 can be thicker to support heavier animals. In some embodiments, the first set of vertical bars 52 is a different material than the second set of vertical bars 52. In some embodiments, one or more of the one or more sets of vertical bars 52 can be configured to telescope.

In some embodiments, the wheels 70 are 1 inches, 1.5 inches, 2 inches, 3 inches, between 1 inches and 3 inches, preferably 1.5 inches. Larger wheels 70 are also contemplated. For larger diameter wheels, the vertical bar 52, the holes 56 and/or the angle A, B, C, and/or D may need to be adjusted to account for the larger diameter. The livestock support system 10 should approximate a desired height to enable the suckling animal to reach the teat of the mother.

Other devices to permit movement are contemplated. The wheels 70 can be ball casters to permit multi-directional movement. For instance the livestock support system 10 can include low-friction discs. The discs can be spherical or cylindrical. The discs can be formed as an endcap on the vertical bar 52. Unlike wheels 70, the discs would not rotate about a central axis.

In some embodiments, the vertical bar 52 is coupled with a ski. In some embodiments, the vertical bar 52 is coupled with a sled rail. The longitudinally extending supports such as skis and sled rails may be more stable than wheels since they do not roll. In some embodiments, skis and sled rails may remain stationary without a lock. In some embodiments, all of the wheels 70 are interchangeable with skis or sled rails. In other embodiments, at least some of the wheels 70 are interchangeable with skis or sled rails (e.g., wheels 70 coupled to front bar 20 are interchangeable with skis but wheels coupled to the back bar 22 are not). In some embodiments, the skis extend the length of the livestock support system 10 (e.g., a ski extends along the right side of the livestock support system 10 between right side bars 40, 44 and a ski extends along the left side of the livestock support system 10 between left side bars 42, 46). In some configurations, the ski or sled rails can include an anchoring structure or the like to reduce the likelihood of unintended movement. Other configurations also are contemplated.

As shown in FIGS. 8A-8B, the vertical bar 52 can be coupled to a wheel bracket 66. The wheel bracket 66 can be coupled to a wheel 70. For instance, the wheel bracket 66 can include a plurality of bolts 72 configured to align with holes (not shown) of a plate of a commercially available wheel 70. In other embodiments, the wheel 70 can be directly coupled to the vertical bar 52 without the intervening wheel bracket 66.

The wheel 70 can include a lock 76 to control (e.g., allow one to stop) the rolling of the wheel 70. For instance, the wheel 70 can be a locking caster wheel. The lock 76 can be depressed to reduce or eliminate the likelihood of further rolling of the wheels. Other locks are possible to prevent the movement of the livestock support system 10.

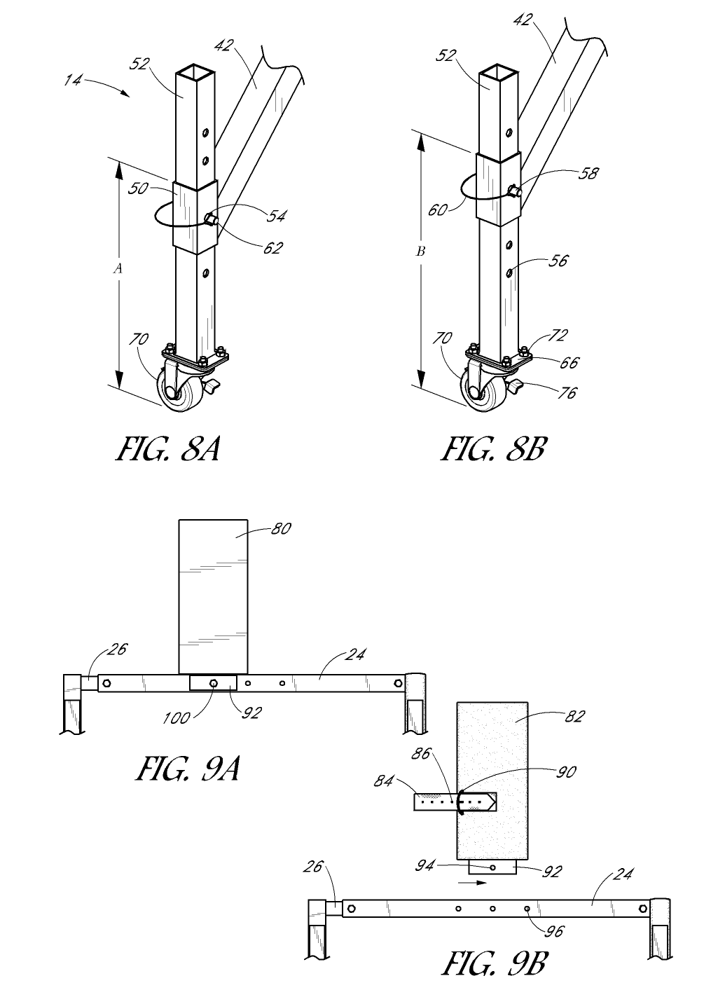

Referring to FIGS. 1, 9A, 9B, the saddle can be coupled to the center support 12. The saddle 16 can provide a level of comfort and support for the suckling animal. The saddle 16 can include a saddle support 80. In some embodiments, the saddle support 80 is generally U shaped to accept the body of the animal. The saddle support 80 can include walls that extend beyond the expected girth of the animal.

The saddle support 80 can include padding 82, as shown in FIG. 9B. The padding 82 can be similar to the padding 36 described above. The padding 82 can reduce or eliminate the likelihood of injury to the body of the animal and support the underside of the animal. The padding 82 can be removable. In some embodiments, the padding 82 can be cheaply replaced. In some embodiments, the padding 82 is washable. The padding 82 can be coupled to the saddle support 80 via removable fasteners (not shown) including snaps, buttons, Velcro, adhesive and the like.

The saddle 16 can include a strap 84. In some embodiments, the strap 84 can be coupled to the padding 82. In other embodiments, the strap 84 can be coupled to the saddle support 80. The padding and/or saddle support 80 can include slots or other features that allow the strap 84 to extend through the padding 82 and/or the saddle support. In some embodiments, the strap 84 is coupled to the saddle support 80 in an area where the padding 82 does not cover the saddle support 80. In some embodiments, the strap 84 is coupled to the center support 12 such as the front bar 20, the back bar 22, the outer longitudinal bar 24, the inner longitudinal bar 26 or some other auxiliary bar not described earlier but that extends from any of the other bars.

In the embodiment shown in FIGS. 9A-9B, the strap 84 includes a plurality of holes 86. The holes 86 can be equally spaced along the length or a portion of the length of the strap 84. The holes 86 can be configured to cooperate with a buckle 90 to secure the strap 84. Other securement mechanisms are possible. For instance, the strap 84 can include a snap-fit buckle or a double ring buckle.

As shown in FIGS. 9A-9B, the saddle 16 can be adjustable along the length of the center support 12. For instance, the saddle support 80 can be coupled to a bracket 92. The outer longitudinal bar 24 can be received within the bracket 92. In some embodiments, the outer longitudinal bar 24 in received within the bracket 92 and telescopes within the bracket 92. In some embodiments, the bracket 92 slides along the outer longitudinal bar 24.

The bracket 92 and the outer longitudinal bar 24 cooperate to change the position of the saddle 16. For instance, the bracket 92 can comprise one or more holes 94 and the outer longitudinal bar 24 can comprise one or more holes 96. A pin 100 can be inserted when a hole 94 of the bracket 92 aligns with a hole 96 of the outer longitudinal bar 24. The pin 100 reduces or eliminates the likelihood of inadvertent movement of the saddle 16.

In some embodiments, different saddles 16 can be utilized with the same center support 12. For instance, a wider and/or longer saddle 16 can be provided that includes the bracket 92. The bracket 92 can be configured to couple with the outer longitudinal bar 24 described above.

The saddle support 80 can be adjusted to support animals having different girths. In some embodiments, the saddle support 80 is adjustable in any dimension (e.g., width, length, height). The saddle support 80 can include opposed plates (not shown) which slide relative to each other. The opposed plates can be locked together using pins, similar to pins described herein, threaded fasteners or the like. In some configurations, the weight of the animal could reduce or eliminate the likelihood of movement of the plates for widthwise and lengthwise adjustable plates.

In some embodiments, the girth of the animal reduces the stability of the livestock support system 10. In such cases, additional width adjustability may be advantageous. For instance, the outer longitudinal bar 24 and the inner longitudinal bar 26 can be adjusted widthwise. The outer longitudinal bar 24 can include opposed plates (not shown) which slide relative to each other. The opposed plates could be locked together using pins, similar to the pins described herein, threaded fasteners or the like.

In some embodiments, a second outer longitudinal bar 24 (not shown) and a second inner longitudinal bar 26 (not shown) can be coupled to the front bar 20 and the back bar 22. In some configurations, the set of outer longitudinal bars 24 can be aligned along the Z-axis. This configuration can be used for smaller animal. The set of outer longitudinal bars 24 can be moved away from each other along the X-axis. A saddle support 80 having two brackets 92 can couple to the set of outer longitudinal bars 24 in the spaced apart configuration. This configuration could provide more support to animals with larger girths.

In some embodiments, the front bar 20 includes an inner bar (not shown) and an outer bar (not shown). The inner bar can telescope or slide within the outer bar to adjust the width of the front bar 20. The back bar 22 can have a similar configuration with an inner bar and an outer bar. The right side bars 40, 44 and the left side bars 42, 46 can be moved away from the center support 12 by movement of the front bar 20 and/or the back bar 22. The wheels 70 can be moved away from the center support 12 by movement of front bar 20 and the back bar 22. This configuration could provide more support to animals with larger girths. By moving the inner bar relative to the outer bar, the footprint of the livestock support system 10 can be increased.

In some embodiments, the right side bars 40, 44 and the left side bars 42, 46 can be pivoted to change the angles A, B, C, and/or D. For instance, the angles A, B, C, and/or D can be increased (e.g., from 100 degrees to 140 degrees) to increase the footprint of the livestock support system 10. In some embodiments, only two angles are increased, for example angle A formed between the right side bar 40 and the front bar 20 and angle B formed between the left side bar 42 and the front bar 20.

The livestock support system 10 can include a handle (not shown) for positioning the livestock support system 10 relative to the mother. The handle can be coupled to the back bar 22, for example but without limitation.

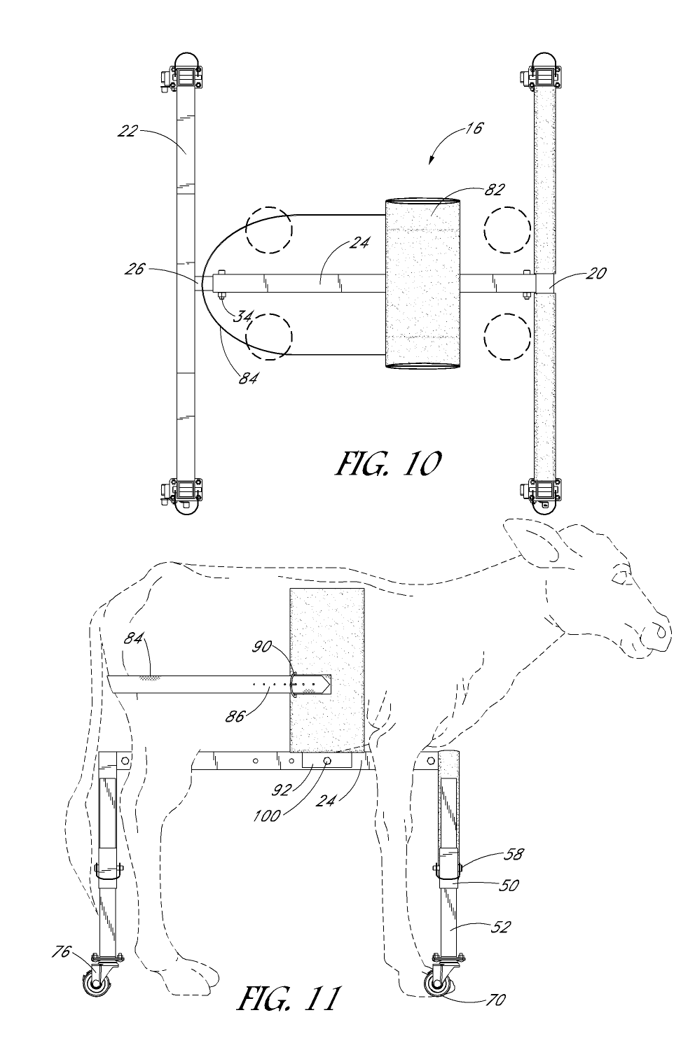

Methods of using the livestock support system 10 are described below. Other methods also are contemplated. FIGS. 10-11 show a calf engaged with the livestock support system 10, however, the use with other animals is similar to the methods described below. In some instances, an animal is born that is too weak to stand. Therefore, the animal cannot reach the teat of its mother to nurse. With commercial agricultural, even this weak calf is a valuable asset. Cows have a lengthy gestation period typically have one calf at a time. Therefore, farmhands try to ensure the survival of each calf.

The livestock support system 10 can be adjusted based on the size of the calf. The length can be adjusted. The width can be adjusted. The height can be adjusted. The position of the saddle can be adjusted. In some configurations, even the width and/or the height of the saddle can be adjusted. For instance, the inner longitudinal bar 26 can slide relative to the outer longitudinal bar 24 to adjust the length. The pin 34 can reduce or eliminate the likelihood of inadvertent adjustment. The vertical bar 52 can slide relative to the bracket 50 to adjust the height. The pin 58 can reduce or eliminate the likelihood of inadvertent adjustment. The bracket 92 can slide relative to outer longitudinal bar 24 to adjust the position of the saddle 16. The pin 100 can reduce or eliminate the likelihood of inadvertent adjustment. The width can be adjusted, as described above. If the livestock support system 10 is typically used with calves, then the pins 34, 58, 100 can remain fixed for extended periods of time.

The calf is picked up by the farmhand. Typically a hand is placed under chest and another hand is placed under the hip. The calf is lowered into the saddle 16 such that the underside of the calf rests against the padding 82. The front legs of the calf are within the livestock support system 10 and near the front bar 20. The back legs of the calf are within the livestock support system 10 and near the back bar 22. The legs of the calf are shown in the top view of FIG. 10. In some configurations, the hoofs of the calf touch the ground or floor. In other configurations, the hoofs of the calf do not touch the ground, for instance if the calf is severely underdeveloped.

As shown in FIGS. 10-11, the saddle 16 is positioned near the calf's front legs, generally near the calf's ribcage. The saddle 16 can be positioned to provide the most support to the calf. This position may restrict the movement of the ribcage but should not impact the ability of the calf to breathe. The saddle 16 can be positioned so that the calf can move some or all joints of its legs. The saddle 16 can be designed to evenly spread pressure over the entire area. The saddle 16 may have some flexibility or “give” to increase the comfort of the saddle 16. The saddle 16 may cause discomfort if the saddle 16 is incorrectly sized (e.g., too narrow) or incorrectly positioned relative to the calf. In other methods, the saddle 16 is positioned in between the calf's front legs and back legs. In other methods, the saddle is positioned near the calf's back legs. In some embodiments of the method, the saddle 16 is positioned prior to lowering the calf into the saddle 16. After the calf is placed within the saddle, the strap 84 is wrapped around the haunches of the calf, as shown in FIG. 11. In some methods, the strap 84 extends from one side of the calf, under the tail, to the other side of the calf. The buckle 90 engages the holes 86 of the strap 84. The strap 84 reduces or eliminates the likelihood of the calf moving backwards relative to the saddle 16. The positioning of the saddle 16 and/or the strap 84 prevents the calf freeing itself from the livestock support system 10. The saddle 16 and/or the strap 84 stabilize the calf within the livestock support system 10.

The livestock support system 10 then is used to move the calf relative to the cow. The wheels 70 allow the livestock support system 10 to roll on the uneven floor of the barn or the ground. The livestock support system 10 is sufficiently stable to be rolled or slid after the calf in placed within. The width of the livestock support system 10 reduces or eliminates the likelihood of the apparatus tipping over with movements of the calf. The length of the livestock support system 10 provides support and comfort along the spine of the animal. The configuration of the livestock support system 10 provides a natural position of the legs and body of the calf. The saddle 16 surrounds the barrel of the calf providing greater support and comfort. The wheels 70 enable the farmhand to easily maneuver the calf into position relative to the cow. In some embodiments, the farmhand utilizes a lock 76 to fix the position of the livestock support system 10. The lock 76 can be easily released, allowing the farmhand to reposition the calf, for example if the cow moves. In other embodiments, the weight of the calf reduces or eliminates the likelihood of inadvertent movement of the livestock support system 10.

The farmhand can then use one or both hands to grasp the head of the calf. The farmhand can position the head of the calf relative to the teat. Some calves will immediately begin to suckle. Other calves may need the farmhand to position the teat within the mouth of the calf and squeeze the teat to encourage suckling. Once the calf begins sucking, the farmhand can release the head. The farmhand can stand or otherwise reposition himself during the feeding. Once the calf is fed, the farmhand can move the livestock support system 10 from near the cow to a position away from the cow. In some embodiments, the strap 84 is released. The farmhand grasps the underside of the calf and lifts the calf vertically. The calf can be disengaged from the livestock support system 10 enabling other animals to use the system.

The positioning of the farmhand during feeding is dramatically improved with the livestock support system 10. Without the system, the farmhand would kneel. The farmhand would place the calf on his thigh and position his thigh under the cow. The shin of the other leg would rest against the floor. The torso of the farmhand would be close to the side of the cow. This positioning prevents the farmhand from moving out of the way if the cow becomes agitated. This positioning also places the farmhand closer and more underneath the cow.

In contrast, with the livestock support system 10, the farmhand can reposition himself relative to the calf. The farmhand need not support the weight of the calf; instead the weight is supported by the livestock support system 10. The farmhand is next to the cow, rather than underneath the cow. This more distant location is more comfortable for the farmhand.

A method of positioning a livestock support system 10 of the embodiments described above comprises lowering the calf within the saddle 16. The method can include the step of positioning the livestock support system 10 in a first position away from the cow, and moving the livestock support system 10 from the first position to a second position to enable suckling. In certain embodiments, after positioning the livestock support system 10 in the second position, a lock 76 is depressed, thereby locking the position of the livestock support system 10. Prior to the livestock support system 10 being in the first position, one of the height, width, or length can be adjusted to accommodate the suckling animal.

Various modifications to the implementations described in this disclosure may be readily apparent to those skilled in the art, and the generic principles defined herein may be applied to other implementations without departing from the spirit or scope of this disclosure. For example, in some configurations, the structure can be “plus-shape” with the supporting frame forming a plus-sign, an x or a cross with the four legs extending generally downward from the supporting framework. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “right,” “left,” “inner,” “outer,” “front,” “back” are sometimes used for ease of describing the figures, and indicate relative positions corresponding to the orientation of the figure on a properly oriented page, and may not reflect the proper orientation of the device as implemented.

Certain features that are described in this specification in the context of separate implementations also can be implemented in combination in a single implementation. Conversely, various features that are described in the context of a single implementation also can be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

In describing the present technology, the following terminology may have been used: The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” means quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but also include individual values and sub-ranges within the indicated range. Thus, included in this numerical range are individual values such as 2, 3 and 4 and sub-ranges such as 1-3, 2-4 and 3-5, etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

It should be noted that various changes and modifications to the presently preferred embodiments described herein will be apparent to those skilled in the art. Such changes and modifications may be made without departing from the spirit and scope of the inventions and without diminishing the attendant advantages. For instance, various components may be repositioned as desired. It is therefore intended that such changes and modifications be included within the scope of the inventions. Moreover, not all of the features, aspects and advantages are necessarily required to practice the present inventions. Accordingly, the scope of the present invention is intended to be defined only by the claims that follow.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. Conjunctions, such as “and,” “or” are used interchangeably and are intended to encompass any one element, combination, or entirety of elements to which the conjunction refers.

What is claimed is:

1. A livestock support system for supporting a suckling animal relative to a mother comprising:
a body portion having at least a first longitudinal bar, the body portion having a length along the longitudinal bar, a width and a height;
at least three wheels coupled to the body portion; and
wherein at least one of the length, the width or the height is adjustable relative to the size of the mother or the sucking animal.

2. The livestock support system of claim 1, further comprising a vertical bar coupled to each wheel

3. The livestock support system of claim 2, wherein the vertical bar can be moved to adjust the height.

4. The livestock support system of claim 3, further a front bar coupled to the first longitudinal bar.

5. The livestock support system of claim 4, further comprising a side bar coupled to the front bar.

6. The livestock support system of claim 5, wherein the angle of the side bar relative to the front bar can be moved to adjust the width.

7. The livestock support system of claim 1, further comprising a second longitudinal bar.

8. The livestock support system of claim 7, wherein the relative movement of the first longitudinal bar relative to the second longitudinal bar adjusts the length.

9. The livestock support system of claim 1, further comprising at least one lock to prevent movement of the wheels.

10. The livestock support system of claim 1, further comprising a saddle configured to be coupled to the first longitudinal bar.

11. The livestock support system of claim 10, wherein the saddle can be adjusted to a different position along at least a portion of the length of the first longitudinal bar.

12. The livestock support system of claim 10, wherein the saddle comprises padding.

13. The livestock support system of claim 10, further comprising a strap configured to be coupled to the saddle.

14. The livestock support system of claim 13, wherein the strap is configured to extend around the haunches of the suckling animal.

15. The livestock support system of claim 13, wherein the strap is configured to prevent movement of the sucking animal in at least one direction.

16. A method of using a livestock support system comprising:
providing a livestock support system comprising a body portion having at least a first longitudinal bar, the body portion having a length along the longitudinal bar, a width and a height;
adjusting at least one of the length, the width or the height relative to the size of a suckling animal or the mother of the suckling animal;
lowering the suckling animal into the livestock support system;
moving a suckling animal relative to the mother.

17. The method of claim 16, wherein adjusting the length comprises moving a second longitudinal bar relative to the first longitudinal bar.

18. The method of claim 16, wherein adjusting the width comprises moving a side bar relative to a front bar, wherein the front bar is coupled to the first longitudinal bar.

19. The method of claim 16, wherein adjusting the height comprises moving a vertical bar relative to a bracket, wherein the bracket is coupled to the body portion.

20. The method of claim 16, wherein lowering the suckling animal comprises lowering the suckling animal into a saddle.

21. The method of claim 16, further comprising the step of securing a strap around the haunches of the suckling animal.
